(19) United States
(12) Patent Application Publication
(10) Pub. No.: US 2025/0002404 A1
(43) Pub. Date: Jan. 2, 2025

(54) GRANULAR MATERIAL BASED ON QUICKLIME, ITS PREPARATION PROCESS AND USES

(71) Applicant: UNICALCE S.P.A., Brembilla (IT)

(72) Inventors: Roberto MARRAS, Lecco (IT); Roberto MORESCHI, Bergamo (IT)

(21) Appl. No.: 18/700,948

(22) PCT Filed: Oct. 13, 2022
(86) PCT No.: PCT/IB2022/000627

§ 371 Date: Apr. 12, 2024

(30) Foreign Application Priority Data
Oct. 13, 2021 (IT) 102021000026225

(51) Int. Cl. C04B 2/04; C04B 2/10; C04B 5/06; C04B 18/02; C04B 111/00

(52) U.S. Cl. CPC C04B 2/04; C04B 2/10; C04B 5/06; C04B 18/023; C04B 2111/00732; C04B 2111/00758; C04B 2111/0087

(57) ABSTRACT

A granular material may include a granular core including quicklime, the granular core having an overall concentration of CaO and MgO equal to or greater than 80% by weight. Optionally, a hydrophobic coating may cover the granular core. The granular core has compressive load until rupture equal to or greater than 50 N/granule, a slaking time t₅₀ in water not exceeding 10 minutes, when the concentration of MgO is greater than 5% by weight with respect to the weight of the granular core, and a slaking time t₆₀ in water not exceeding 6 minutes, when the concentration of MgO is less than or equal to 5% by weight with respect to the weight of the granular core. The present disclosure further relates to a process for preparing the granular material and to the use of the granular material in a metallurgical process or in the treatment of agricultural soil.

### FIELD

The present disclosure refers to an air quicklime-based granular material especially suitable for use in metallurgical processes and in the treatment of agricultural soils. Furthermore, the present disclosure concerns a method of preparation and related uses of the aforesaid granular material.

### BACKGROUND

As is well known, air quicklime (hereinafter also referred to only as “quicklime”) is widely used in modern steelmaking industry, both in metallurgical processes for the production of metals and alloys starting from minerals and in metallurgical processes for the production of metals and alloys starting from metal scrap, metal by-products and metal waste. In the aforesaid metallurgical processes, for example, quicklime is used in the steps of agglomeration of the particles of the ferrous minerals, smelting and refining of the metal or metal alloy. In particular, in blast furnaces, lime is used to remove sulfur from pig iron, whereas in converter furnaces (e.g. Basic Oxygen Furnace—BOF), where the decarburization of pig iron and the conversion into steel take place, it is used as a fluxing agent for the removal of impurities (e.g. sulfur, phosphorus, etc.) and the correction of the content of other elements (e.g. silicon, manganese, etc.).

In metallurgical melting processes in the Electric Arc Furnace (EAF) or Ladle Furnace (LF) in which steel refining is completed, quicklime is used as a purifying or drossing-off agent for steel. In these applications, quicklime typically favors the formation of a basic slag, characterized by a balanced chemistry and correct viscosity in order to have satisfactory diffusion conditions at the metal/slag interface, which is capable of neutralizing the acidic elements and of facilitating the removal, by metal/slag partition, of impurities such as sulfur, silicon and phosphorus present in the molten steel bath. The correct mass balance and full saturation of the slag achieved by using quicklime are also necessary for the safeguard of the refractory linings as well as for the formation of an effective foamy slag capable of ensuring adequate coverage of the electric arc.

Quicklime is generally used in the metallurgy industry in the form of lumps, briquettes, pellets, granules or powder. The finer fractions (pellets, granules and powders) are generally handled by means of pneumatic conveying systems and injected into the melting furnaces by means of lances using air, oxygen or another gas as a conveying agent. The granules typically have a nominal particle size distribution of about 2 mm-12.5 mm.

Quicklime used in the steelmaking industry is mainly obtained by calcination (decarbonation) of limestone (CaCO₃) or dolomitic rock (CaCO₃·MgCO₃) into lumps and subsequent comminution of the calcined lumps, followed by possible treatments classifying the particle size of the material in order to obtain a product in granular form with the desired particle size distribution. Hereinafter, granular quicklime obtained by comminution of quicklime in lumps is also referred to as “natural granular quicklime”.

Natural granular quicklime has a high mechanical resistance to compression, which is mainly due to the fact that the particles composing it form granules having a limited porous volume and therefore very compact. However, since the granules have an irregular shape, as a result of handling, the granular material has a high tendency to generate significant amounts of fine powders with consequent qualitative deterioration of the product (e.g. degradation of the original particle size distribution), which in the case of handling in pneumatic systems can give rise to problems of clogging of the conveying lines.

In addition, natural granular quicklime, being generally a compact material with a relatively low specific surface area and porosity, when used in metallurgical processes exhibits a lower dissolution efficiency into the slag and lower chemical reactivity, characteristics that imply higher consumptions of granular material.

Natural granular quicklime is moreover highly hygroscopic and it therefore tends to absorb atmospheric moisture, forming hydroxide species (Ca(OH)₂) that further reduce the chemical reactivity of the material. In addition, the use of hydrated products in metallurgy is highly undesirable, since the introduction of water, even in a moderate amount, in melting furnaces increases the thermal consumption of the melting process and represents a source of hydrogen that can give rise to steel embrittlement phenomena.

In the state of the art, it is also known to produce quicklime for metallurgical use or for use in agriculture or in the production of glass by granulation or pelletizing processes in which quicklime or hydrated lime in powdered form is used as a starting material.

WO 2021078878 A1, for example, describes the preparation of calcium-based compacted granules, in particular spheroidal/lenticular, crush-resistant pellets with a maximum size of less than 10 mm and a density of at least 1.6 g/cm³. The preparation process is a dry process, in which the starting material, which consists mainly of powdered quicklime, is compacted by means of rollers to form tablets which are subsequently crushed and sieved until a homogeneous product formed by spheroidal/lenticular pellets is obtained. The pellets may be coated with a coating capable of delaying the absorption of water and/or moisture.

Granular quicklime is also used in industrial processes as a sorbent material, for example in flue gas treatment installations for the removal of acid gases or for the absorption of ambient moisture, or for the preparation of refractory materials.

EP 1 867 620 A1, for example, deals with a wet production process of granules of a porous material comprising calcium oxide (CaO) or a mixture of calcium oxide, magnesium oxide and relative hydroxides, having a high mechanical strength. The granular material is used as an absorber of moisture or of acid gases and halogen compounds.

CN 106186021 A is about a process for producing a calcium oxide (CaO)-based porous granular material suitable for the preparation of calcium oxide-based refractory materials. The granulation process is a wet process carried out with the aid of a high-shear mixer in which calcium hydroxide is used as the starting material.

Granular quicklime finds also application in soil treatment, for example in agronomy to modify the pH of a soil (so-called liming). Also for this application it is required that the lime is available in granular form, with granules having specific morphological-dimensional characteristics and adequate mechanical strength, for example to allow the optimal distribution on the soil (dosage precision per unit of treated surface, low product loss and limited generation and dispersion of dust, etc.), for example with the spreading devices commonly used in agronomy.

In view of the aforesaid state of the art, the Applicant was faced with the problem of providing a granular quicklime, especially suitable for use in metallurgy and in the treatment of agricultural soils, capable of overcoming the drawbacks highlighted by the granular materials of the prior art. In particular, an object of the present disclosure is to provide a granular quicklime that generates a limited amount of fine powders during handling and, preferably, whose reactivity remains substantially unchanged during storage and up to the time of use.

### SUMMARY

The Applicant has now found that this and other objectives, which will be better illustrated in the description and in the examples below, can be achieved by a granular material comprising a quicklime-based granular core, which possesses a high mechanical strength, measurable in terms of compressive strength (ultimate compressive load) and wear resistance deriving from dynamic stresses, and a high reactivity, measurable in terms of slaking time in water t₅₀ or t₆₀, and where the granular core is optionally externally coated with a hydrophobic coating.

The particular characteristics of mechanical resistance to compression and resistance to abrasion of the granules, as well as the spheroidal geometric conformation of the granules (substantially without sharp edges), reduce the formation of fine powders following the handling of the material, thus limiting the degradation of the particle size curve of the product, the clogging of the pneumatic handling systems and the generation of fugitive dust emissions.

Advantageously, the presence of a hydrophobic coating layer, which decomposes at the temperatures typically used in metallurgical processes (e.g. BOF, EAF, LF), slows down or prevents the absorption of water or atmospheric moisture by the granules in a substantially complete way, thus preserving the reactivity of the quicklime granular core during storage, until use. The hydrophobic coating not only keeps the granules highly reactive until the time of use and thus ensures a higher effectiveness of the material compared to the products of the prior art, it also prevents the introduction of undesired substances (e.g. moisture, hydrogen, etc.) into the metallurgical process in which the granular material is used.

The spheroidal conformation of the granules, in particular when these comprise the hydrophobic coating, makes the granular material extremely flowable and prevents undesired agglomeration phenomena, thus improving the problems typically associated with the storage of powdered and granular products, such as cohesive phenomena with the formation of compact agglomerates or mechanical interlocking phenomena with consequent difficulty in the extraction from the storage silos, dosage of the material and qualitative deterioration of the particle size distribution.

The granular material according to the present disclosure is obtainable by wet granulation of hydrated powdered air lime (hereinafter also referred to only as “hydrated lime”) with a granulating fluid comprising water and, optionally, binding additives. The formation of the granules having the innovative characteristics described above is favored by the use of high-shear mixing systems.

The advantages of the granular quicklime described herein can also be exploited for industrial applications of a non-metallurgical type, such as the treatment of a soil, for example to modify the pH of agricultural soils (so-called liming). For this type of uses, the quicklime is preferably used in the form of granules without the hydrophobic coating.

In accordance with a first aspect, therefore, the present disclosure concerns a granular material comprising:
a granular core comprising quicklime, said granular core having an overall concentration of CaO and MgO equal to or greater than 80% by weight;
optionally, a hydrophobic coating which covers said granular core;
and wherein said granular core has:
ultimate compressive load equal to or greater than 50 N/granule,
a slaking time t₅₀ in water not exceeding 10 minutes, when the concentration of MgO is greater than 5% by weight with respect to the weight of the granular core;
a slaking time t₆₀ in water not exceeding 6 minutes, when the concentration of MgO is equal to or less than 5% by weight with respect to the weight of the granular core.

In accordance with a second aspect, the present disclosure concerns a process for preparing said granular material comprising:
a. preparing a mixture comprising:
a1. hydrated lime having an overall concentration of CaO and MgO equal to or greater than 80% by weight, said percentage referring to the weight of the calcined hydrated lime;
a2. a granulating fluid comprising water;
b. mixing said mixture until obtaining wet granular cores comprising particles of said hydrated lime;
c. calcining said wet granular cores to obtain calcined granular cores comprising quicklime;
d. optionally, coating said calcined granular cores with a hydrophobic coating layer to obtain said coated granular material.

In accordance with a third aspect, the present disclosure concerns the use of said granular material in a metallurgical process.

In accordance with a further aspect, the present disclosure concerns the use of the aforesaid granular quicklime for the treatment of an agricultural soil.

Furthermore, the aforesaid granular cores preferably possess one or more of the following characteristics (referred to granular cores without the hydrophobic coating layer):
particle size distribution, determined by dry-sieving by shaking (EN 933-1:2012) in sieves with square-shaped apertures (EN 933-2:2020), characterized in that 100% by weight of the granules passes through the sieve with aperture of 12.5 mm;
average diameter, determined on the basis of the aforesaid particle size distribution, between 2.5 and 5.5 mm, preferably between 3 and 5 mm;
an IST₁ shatter test index lower than 1.5 percentage points and/or an IST_{0.5} shatter test index lower than 0.5 percentage points, where said indices are defined below in this description;
specific surface area BET in the range 10-40 m²/g;
total pore volume (BJH) in the range 0.05-0.30 cm³/g.

Further features and advantages of the present disclosure will be apparent from the following detailed description.

### DETAILED DESCRIPTION

For the purposes of the present disclosure, in the following description and claims, the definitions of numerical ranges include the individual values within the range and its extremes, unless otherwise specified.

The compositions according to the present disclosure may “comprise”, “consist of” or “consist essentially of the” essential and optional components described in the present description and in the appended claims. For the purposes of the present description and of the appended claims, the term “consist essentially of” indicates that the composition or the component may include additional ingredients, but only to the extent that the additional ingredients do not materially alter the essential characteristics of the composition or component.

As used in the present description and in the relative claims, the term “granular quicklime” refers to granular cores comprising air quicklime without the hydrophobic coating.

The term “coated granular material” instead refers to coated granular air quicklime, i.e. granular quicklime in which the granular cores are coated with the hydrophobic coating.

The granular cores forming the granular quicklime and the coated granular material according to the present disclosure are formed from agglomerates of quicklime particles.

In general, as is well known, quicklime, depending on its origin, may predominantly consist of calcium oxide CaO (calcium quicklime) or of mixed calcium and magnesium oxide CaO·MgO (magnesium quicklime, dolomitic quicklime). Lime can also exist in hydrated form (so-called “slaked lime”), and is hereinafter represented by the formula Ca(OH)₂ (calcium hydrated lime) or the formula Ca(OH)₂·MgO (hydrated magnesium lime, hydrated dolomitic lime), where the magnesium oxide MgO can be found partially in hydrated form.

The granular quicklime according to the present disclosure comprises calcium and magnesium, expressed as CaO and MgO, in an overall amount CaO+MgO equal to or greater than 80% by weight with respect to the weight of the granular cores.

The chemical composition of the granular quicklime, in particular the CaO, MgO, CO₂ and SO₃ content, is intended to be determined in accordance with standard EN 459-2:2010.

In the case of hydrated lime, which is the starting material used to prepare the granular material according to the present disclosure, the CaO and MgO concentrations refer to the calcined material, i.e. net of free water and bound water, where the free water is the film water, combined by surface absorption and retained by physical forces only, removable by a drying heat treatment at 105° C. up to weight constancy and the bound water is the water chemically combined with calcium oxide and with the magnesium oxide with which it forms the corresponding hydroxides, removable by a calcination heat treatment at 600° C. up to weight constancy.

Based on the MgO content, the granular quicklime according to the present disclosure is classified into:
calcium quicklime, if the MgO content is equal to or less than 5% by weight;
magnesium quicklime, if the MgO content is more than 5% by weight and less than 30% by weight;
dolomitic quicklime, if the MgO content is equal to or greater than 30% by weight and, preferably, equal to or less than 42% by weight.

The granular quicklime may further comprise impurities of other elements (e.g., sulfur, silicon, iron, aluminum), preferably in an overall amount (expressed in terms of the summation of the amounts of the corresponding oxides SO₃, SiO₂, Fe₂O₃ and Al₂O₃) not exceeding 1.0%, more preferably less than 0.5%, and even more preferably less than 0.2% by weight with respect to the weight of the granular cores.

Depending on its intended use, the granular quicklime may also include specific additives to perform additional functions. For example, for use in the treatment of an agricultural soil, the granular quicklime may also comprise one or more additives, such as fertilizers, soil nutrients, soil improvers, etc.

For use in metallurgy industry, the granular quicklime may also comprise one or more additives, such as calcium fluoride, calcium aluminates, calcium silicates, iron alloys (e.g. FeMn, FeMo, FeCr, FeSi, FeTi, etc.), specific alloying elements in the form of oxide or in metallic form.

The granular cores of the quicklime according to the present disclosure have a spheroidal conformation, i.e. they have a substantially spherical or ellipsoidal shape, and are substantially without sharp edges.

Preferably, the granular quicklime comprises at least calcium, or magnesium, or dolomitic quicklime. Calcium quicklime, magnesium quicklime and dolomitic quicklime can be used individually or in a mixture.

In a preferred embodiment, the granular quicklime is a dolomitic quicklime wherein the Mg/Ca weight ratio is from 0.36 to 0.62, more preferably from 0.52 to 0.62 and/or the Mg/(Ca+Mg) ratio is in the range 0.27-0.38, more preferably in the range 0.34-0.38.

In another preferred embodiment, the granular quicklime is a calcium quicklime wherein the Mg/Ca weight ratio is from 0.002 to 0.04, preferably from 0.01 to 0.02, and/or the Mg/(Ca+Mg) ratio is in the range 0.002-0.04, more preferably in the range 0.01-0.02.

In a further preferred embodiment, the granular quicklime is a magnesium quicklime wherein the Mg/Ca weight ratio is comprised between 0.05 and 0.35, more preferably between 0.06 and 0.25, and/or the Mg/(Ca+Mg) ratio is in the range 0.05-0.26, preferably in the range 0.06-0.20.

For the purposes of this description and of the appended claims, the particle size distribution (PSD) of the granules is determined by dry-sieving by shaking in accordance with the standard method EN 933-1:2012 in test sieves with square-shaped apertures as reported in standard EN 933-2:2020.

Preferably, the particle size distribution is characterized in that 100% by weight of the granules passes through the sieve with aperture of 12.5 mm.

In one embodiment, preferably the particle size distribution is characterized in that at least 90% by weight of the granular mass, more preferably at least 95% by weight, even more preferably at least 98% by weight, is formed by granular cores having size in the range 1-10 mm (i.e. passes through the sieve with aperture of 10 mm and does not pass through the sieve with aperture of 1 mm), even more preferably in the range 1.4-9 mm and even more preferably in the range 2-8 mm.

Preferably, the particle size distribution is characterized by a value of the index Di equal to or greater than 1.5 mm, more preferably in the range 2-3 mm.

Preferably, the index D₅₀ has a value equal to or greater than 2.5 mm, more preferably in the range 3-6 mm.

Preferably, the index D₉₀ has a value equal to or greater than 4.5 mm, more preferably in the range 5-8 mm.

Preferably, the amplitude of the particle size distribution curve has a ratio between the indices D₉₀ and D₁₀ (D₉₀/D₁₀) in the range 1.5-4, preferably in the range 1.05-1.50.

The values of the indices D₁₀, D₅₀ and D₉₀ are calculated from the cumulative particle size distribution curve and correspond, respectively, to the sizes of the granules for which 10%, 50% and 90% by weight of the granular material has a size less than the value of D₁₀, D₅₀ and D₉₀. Other indices “Dₓ”, where x is a number between 0 and 100, can be determined in the same way, so that for a given value of Dₓ it results that x % by weight of the material has a size equal to or less than the value Dₓ.

The air quicklime-based granules of the granular material according to the present disclosure possess high mechanical strength. The mechanical strength can be determined by measuring the compressive load until rupture of the granules or the resistance of the granules to abrasion and to breakage following dynamic stresses.

For the purposes of the present description and of the appended claims, the compressive load until rupture of the granular lime and the resistance to abrasion and to breakage following dynamic stresses are understood to be determined according to the methods described in the examples.

The granular cores of the granular quicklime according to the present disclosure, preferably, have a compressive load until rupture in the range 40-90 N/granule. More preferably, the compressive load until rupture is at least equal to 50 N/granule. In particular, in the case of dolomitic lime, the compressive load until rupture is preferably at least 60 N/granule. These values are comparable to the values observed for natural granular quicklime, although for the latter the values of compressive load until rupture are generally higher, both for an intrinsic greater degree of structural compactness as well as in consideration of the fact that natural granular quicklime contains residual carbonate components with particular hardness deriving from an incomplete calcination of the carbonate rock in industrial-scale plants.

The quicklime granules according to the present disclosure have a high resistance to abrasion and to breakage following dynamic stresses. This property of the granular cores can be evaluated through a “shatter test” carried out according to the methods described in the examples. During the shatter test, the granular material is subjected to a series of controlled impacts, inside a test chamber consisting of a cylindrical steel container kept rotating, which generate a fraction of fine particles that modifies the original particle size distribution of the material. The extent of the variation of the particle size curve determined at the end of the shatter test provides an indication of the resistance to abrasion and to breakage of the granular material. Quantitatively, the aforesaid variation of the particle size curve is indicated in the present description by means of the “shatter test index” (ISTₓ)

$${IST}_{x} = {FP}_{f} - {FP}_{i}$$

where:
FPᵢ is the percentage fraction by weight of the granular material passing through the sieve having square aperture with side x mm before the test;
FP_{f} is the percentage fraction by weight of the granular material passing through the same sieve after the test;
x is the net opening of the aforesaid sieve, i.e. the length in mm of the side of the square aperture of the sieve.

The shatter test index is expressed in percentage points (pp).

The granular material according to the present disclosure preferably has an IST₁ (arithmetic difference, expressed in terms of percentage points pp, of the percentage fraction by weight passing through the square aperture sieve with side 1 mm before and after the execution of the shatter test) lower than 1.5 pp, more preferably lower than 0.7 pp, even more preferably lower than 0.5 pp.

The granular material according to the present disclosure preferably has an IST_{0.5} (arithmetic difference, expressed in terms of percentage points pp, of the percentage fraction by weight passing through the square aperture sieve with side 0.5 mm before and after the execution of the shatter test) lower than 0.5 pp, more preferably lower than 0.3 pp, even more preferably lower than 0.2 pp.

The reactivity of the granular quicklime can be determined by means the water reactivity test according to standard EN 459-2:2010. The reactivity test is carried out on the granular material as it is, i.e. without reducing the particle size to values≤0.2 mm (as is required instead by the standard for the materials not passing 100% through a 5 mm sieve).

The reactivity test involves slaking the quicklime (150 g) in distilled water in a water/lime mass ratio equal to 4:1, under adiabatic conditions inside a Dewar vessel in which the water/lime system is kept stirring (300 rpm), and recording the evolution over time of the temperature starting from the initial value of 20° C. and until completion of the reaction (the reaction is considered completed when the temperature of the sample reaches the maximum value T′ₘₐₓ and stabilizes on this, without further increasing and in any case after 50 minutes in the event that the temperature does not stabilize at a maximum value). The temperature (in ° C.) and time measurements allow to define a reactivity curve from which it is possible to obtain the indices t₅₀ and t₆₀, corresponding to the time necessary to reach the temperature of, respectively, 50° C. and 60° C. For the purposes of the present disclosure, the value t₅₀ is used to characterize the reactivity of quicklime granules having an MgO content greater than 5% by weight, whereas the value t₆₀ is used to characterize the reactivity of quicklime granules having an MgO content lower than or equal to 5% by weight.

Preferably, when the concentration of MgO is greater than 5% by weight of the weight of the granular core, the slaking time t₅₀ in water is equal to or lower than 10 minutes, preferably equal to or lower than 5 minutes, more preferably equal to or lower than 3 minutes, even more preferably equal to or lower than 2 minutes and even better equal to or lower than 1 minute.

Preferably, when the concentration of MgO is equal to or lower than 5% by weight of the weight of the granular core, the slaking time t₆₀ in water is equal to or lower than 6 minutes, preferably equal to or lower than 4 minutes, more preferably equal to or lower than 2 minutes, even more preferably equal to or lower than 1 minute.

Another index that is used to delineate the speed of the slaking reaction of quicklime in water is represented by the time required to complete the reaction at 80% (tᵤ) corresponding to the temperature value (Tᵤ), expressed in degrees Celsius, at which the reaction is completed at 80% calculable according to the relation Tᵤ=[(0.8×T′max)+(0.2×T₀)], To being the initial temperature (in degrees Celsius) and T′ₘₐₓ the maximum temperature (in degrees Celsius) reached by the water/lime system.

The granules of the granular quicklime according to the present disclosure possess specific surface area BET and porosity BJH that are relatively high compared to the natural granular quicklime.

Preferably, the specific surface area BET of the granular cores is in the range 10-40 m²/g, preferably in the range 12-35 m²/g.

In particular, in the case of calcium quicklime, the specific surface area BET of the granular cores is more preferably in the range 16-30 m²/g; in the case of dolomitic quicklime, the specific surface area BET is more preferably in the range 18-35 m²/g.

With regard to porosity, the granular cores preferably have a total pore volume (BJH), in the range 0.05-0.40 cm³/g. In particular, in the case of calcium quicklime, the aforesaid volume BJH is more preferably in the range 0.09-0.25 cm³/g; in the case of dolomitic quicklime, the aforesaid volume BJH is more preferably in the range 0.10-0.30 cm³/g.

For the purposes of the present disclosure, the specific surface area (BET) of the granular cores is understood to be determined by multi-layer physical adsorption of nitrogen onto the surface of the uncoated granular material in accordance with the BET method; the total pore volume (BJH) is understood instead to be determined by nitrogen desorption isotherms and calculated on the assumption of pores having a cylindrical geometry in accordance with the BJH method.

It is to be noted that, although the specific surface values BET and the total volume of the pores BJH are relatively high compared to those of the natural granular quicklime, the granular material according to the present disclosure still possesses excellent mechanical properties, in particular compressive strength.

The granular lime according to the present disclosure can be prepared by wet granulation according to the methods known to the person skilled in the art. The wet granulation technique is based on agglomeration of hydrated lime powder particles by means of a granulation liquid, followed by heat treatment of the wet granules to remove the granulation liquid and obtain the quicklime-based granular material.

Compared to dry granulation, the wet granulation technique makes it possible to obtain granules having a spheroidal conformation.

In particular, the granular lime is preferably prepared by granulating hydrated powdered lime having the desired calcium and magnesium content for the final granular quicklime. In one embodiment, hydrated lime comprising calcium and magnesium in an overall concentration (expressed as CaO+MgO) equal to or greater than 80% by weight is used, wherein said percentage by weight refers to the weight of the calcined hydrated lime, i.e. without free water and chemically bound water.

Preferably, the particle size distribution of the particles of the starting hydrated lime, determined by laser diffraction particle size analysis, is characterized in that at least 90% by weight of the particle mass, preferably at least 95% by weight, even more preferably at least 98% by weight, is formed by particles having a size in the range 0.5-200 micrometers, more preferably in the range 1-100 micrometers and even more preferably in the range 1.5-80 micrometers.

Preferably, the particle size distribution of the hydrated lime is characterized by one or more of the following indices: index D₁₀ between 1.5-3 micrometers; index D₅₀ between 5-30 micrometers; index D₉₀ between 40-70 micrometers; average diameter (Dₐᵥₑ) in the range 10-45 micrometers.

Preferably, the starting hydrated lime has a specific surface area BET greater than 9 m²/g, more preferably greater than 12 m²/g and even more preferably greater than 16 m²/g. Preferably, the starting hydrated lime has a total pore volume BJH greater than 0.04 cm³/g, more preferably between 0.06 cm³/g and 0.15 cm³/g and even more preferably between 0.07 cm³/g and 0.10 cm³/g.

The starting hydrated lime is commercially available or can be prepared by mixing water to powdered quicklime. Advantageously, the quicklime powder to produce the starting hydrated lime or the hydrated lime powder to produce the granular cores may comprise or consist of the fraction of residual fine powders that are generated in the different steps of the lime production cycle, such as for example the lime powders generated in the operation of the lime kilns or the lime powders captured by the environmental pollution control systems present on the production plants, such as the systems at service of the comminution and particle size separation processes or at silo unloading and vehicle loading points.

The process of preparing the granular lime comprises preparing a mixture comprising the hydrated powdered lime and a granulating fluid comprising water. The mixture is prepared by mixing the two components. Preferably, the granulating fluid is gradually added to the powder while the powder is kept under mixing within the granulator.

The granulating fluid may optionally contain one or more binding agents to improve the compactness and the mechanical strength of the final granular material. The binding agent preferably comprises: cellulosic-based compounds (e.g. hydroxypropyl methylcellulose), hydrolyzed polyvinyl esters (e.g. polyvinyl alcohol), casein-based compounds (e.g. calcium caseinate), vinyl acetate-based compounds (e.g. ethylene vinyl acetate) or a mixture of the aforesaid compounds. Preferably, the concentration of the binding agent is in the range 0.1%-15% by weight with respect to the hydrated lime, more preferably between 0.3%-10% by weight with respect to the hydrated lime and even more preferably in the range 0.5%-5% by weight with respect to the weight of the hydrated lime. In a preferred embodiment, the granulating fluid does not comprise binding agents.

For the formation of the mixture (step of wetting the hydrated lime powder), the amount of granulating fluid employed is preferably in the range of 0.27-0.39 kg/kg of hydrated lime, more preferably in the range of 0.30-0.36 kg/kg of hydrated lime and even more preferably in the range of 0.32-0.35 kg/kg of hydrated lime.

The mixture comprising the wet hydrated lime powder is subjected to mixing under granulation conditions to form wet granular cores. During mixing, the wet powder particles aggregate with each other to form cores or “nuclei” of hydrated lime, which progressively grow in size (nucleation step) and finally agglomerate with each other (coalescence step) to form the wet granular cores comprising hydrated lime particles (also called “green” granules).

The wet granular cores are then subjected to calcination to obtain granular cores comprising quicklime. Calcination is preferably carried out at a temperature in the range 350-750° C. Calcination can be carried out at atmospheric pressure or at reduced pressure, for example in the range 1-300 Pa. At atmospheric pressure, calcination is preferably carried out at a temperature in the range 400-650° C., more preferably in the range 450-600° C.

In general, calcination results in granular cores being obtained preferably having a residual content of chemically bound water of less than 1% by weight, more preferably less than 0.5% by weight and even more preferably less than 0.2% by weight and possibly less than 0.1% by weight, with respect to the weight of the calcined granular cores.

The duration of the calcination depends on the calcination temperature and on the amount of residual water desired in the final product. Generally, the duration of the calcination heat treatment is in the range from 30 minutes to 6 hours.

In one embodiment, the calcination stage is preceded by a drying heat treatment of the green granules to substantially remove the free water. Drying is preferably carried out at a temperature in the range 100-250° C. Preferably, drying is carried out until obtaining a dried granular material having a residual content of free water of less than 1% by weight, more preferably less than 0.5% by weight, and even more preferably less than 0.2% by weight of the dried granular cores.

At the end of drying, the granular material may be subjected to screening before being calcined.

In one embodiment, the granular material may be subjected to drying and calcination in two distinct heat treatment stages, interspersed with cooling of the dried granular material.

In another embodiment, drying and calcination can be carried out in a continuous process, for example by means of a temperature gradient furnace, where the granular material crosses the furnace passing in successive zones having increasing temperature or by means of a rotary drum furnace in which the temperature is gradually raised from the initial temperature to the drying temperature and thus to the calcination temperature.

The granules can be prepared with the granulation devices of the type known in the art for the wet preparation of granular materials, such as high-shear granulators or fluid bed granulators. Preferably, a high-shear granulator is used. Typically, a high-shear granulator comprises a mixing chamber (vessel) within which there is a mixing tool (impeller) for kneading the powder together with the granulating fluid. The mixing chamber may include a wall scraper (scraper) and/or a fragmenting device (chopper) that favors the cleaning of the wall of the mixing chamber and the breakage of the bulkier aggregates and thus the formation of the granules with the desired size. The granulating fluid is introduced into the mixing chamber generally through one or more openings, which may be provided with, for example, spraying nozzles.

In a particularly advantageous embodiment, the granular material according to the present disclosure comprises a hydrophobic coating that externally coats the granular cores. Mainly, the hydrophobic coating makes it possible to substantially completely delay or prevent the absorption of water and/or atmospheric moisture, thus preserving the reactivity of the granular quicklime during transport, storage and handling.

When the granular material is intended for use in a hot metallurgical process, the hydrophobic coating is formed by a material that thermally decomposes at the temperature of use of the granular material (e.g. operating temperature of the BOF, EAF, LF furnaces).

Materials and devices known in the art in the sector for preparing coated quicklime-based products may be used to produce the hydrophobic coating.

In a preferred embodiment, the hydrophobic coating comprises a compound or composition selected from: stearic acid, calcium stearate, silane or siloxane compounds, waxes or paraffinic oils, petrolatum compounds, or a mixture of the aforesaid compounds.

In one embodiment, the hydrophobic coating comprises at least one compound belonging to the petrolatum class. Petrolatums, such as the compositions identified by the numbers CAS RN 8009-03-8, CAS RN 64742-61-6 and CAS RN 64743-01-7 are complex mixtures of hydrocarbons in the liquid, semi-solid or solid state at room temperature, obtained by treating the crude oil distillation residues. Petrolatum is predominantly formed by liquid and crystalline saturated hydrocarbons with a number of carbon atoms generally greater than 20, most of which have linear or branched chains.

The material forming the hydrophobic coating can be applied by spraying onto the granular cores or by mixing with them or by immersing the granular cores in the hydrophobic coating.

At room temperature, the coating material may be in the liquid state or in the semi-solid state or in the solid state. Liquid coating materials may be deposited on the outer surface of the granular cores by spraying the coating material in the liquid state or by mixing the granular cores and the coating material in the liquid state or by immersing the granular cores in the coating material in the liquid state.

Semi-solid and/or solid coating materials can be heat treated until they become liquid and then applied to the granular cores as described above. Alternatively, the aforesaid materials may be mixed in the semi-solid and/or solid state with the granular cores and the homogeneous mixture thus obtained is subsequently heat-treated to melt the coating material and make it adhere to the surface of the granular cores.

The coating material is deposited on the outer surface of the granules, where it forms a thin layer of hydrophobic coating capable of substantially slowing down or preventing the absorption of water or moisture onto the granular cores.

The hydrophobic coating is present on the granules preferably in an amount by weight generally equal to or less than 15% by weight with respect to the weight of the granular cores, preferably equal to or less than 10% by weight, more preferably equal to or less than 5% by weight and even more preferably less than 3% by weight.

In the state of the art, the application of hydrophobic coatings to the granular quicklime is known in the sector of the production of desiccant materials for food preservation. An example of coated quicklime-based granular material for use in the food industry is described for example in JP 4279296 B2.

The granular quicklime according to the present disclosure can advantageously be employed in a metallurgical process, for example as a fluxing agent or as a slag-forming agent. In particular, in the case of use in BOF, EAF and LF furnaces, the granular quicklime can be used as a foamy slag-forming agent and/or as a steel purifying and refining agent, for example by combining the impurity elements to be removed into the slag. For the uses in a metallurgical industry, the granular quicklime is preferably employed in the form in which the granular cores comprise the hydrophobic coating layer.

The granular quicklime according to the present disclosure can also be used in treating an agricultural soil, especially in the agronomic field where it can be used for example to modify the pH of the soil to favor the growth of agricultural crops.

The following examples are provided purely for the purpose of illustration of the present disclosure and should not be regarded as a limitation of the scope of protection defined by the appended claims.

### EXAMPLES

### Preparation of the Granular Material—Samples A-G

Seven series (Samples A-G) each one consisting of five granular material samples according to the present disclosure were prepared in the laboratory starting from industrially produced dolomitic hydrated air lime, classified DL90-30-S1 according to the designation given in standard EN 459-1:2015 (“Building lime—Part 1: Definitions, specifications and conformity criteria”), also known as “type N” (i.e., semi-hydrated dolomitic lime Ca(OH)₂MgO).

Based on this classification, the composition of the starting material was as follows:
calcium and magnesium content in terms of the summation CaO+MgO≥90%;
magnesium content (MgO)≥30%;
residual CO₂ content≤6% and SO₃ content≤2%;
the aforesaid percentages being percentages by weight referred to the weight of the calcined starting material at 600° C. up to weight constancy.

The starting material was characterized by the following particle size distribution determined by laser diffraction technique: D₁₀=1.884 μm, D₅₀=22.945 μm, D₉₀=68.625 μm, Dₐᵥₑ=29.794 μm.

The starting dolomitic hydrated air lime also had a specific surface area BET equal to 16.9 m²/g, a total pore volume BJH equal to 0.08 cm³/g, said pores having an average diameter of 17.3 nm.

The granular quicklime according to the present disclosure was prepared by means of a wet granulation process of the aforesaid hydrated dolomitic lime, followed by a calcination heat treatment, as reported below.

The wet granulation process was carried out, according to a “batch” mode process with a total duration equal to 10 minutes, with the aid of an intensive bench high-shear mixer. The mixer included a rotating inclined vessel with 5-litre capacity and a high-speed rotating eccentric mixing tool. The vessel and the mixing tool were configured to rotate according to opposite rotation directions.

For each batch, about 2650 g of dolomitic hydrated air lime and about 900 g of granulation liquid consisting of water and optionally a binding agent (binding agent concentration equal to 2% by weight with respect to the weight of the dolomitic hydrated lime) were overall loaded into the vessel by successive additions.

In a first step, into the vessel it was loaded dolomitic hydrated air lime in an amount equal to 75% of the total mass amount used and water (granulation liquid) in an amount equal to about 78% of the mass amount used (corresponding to 26% with respect to the mass of dolomitic hydrated air lime used in the process). The mixture of hydrated lime and granulation liquid was obtained by setting a rotation speed of 350 rpm for the vessel and 3000 rpm (counter-current rotation) for the mixing tool. This mixing regime was maintained for a period of time equal to 4 minutes and, at regular intervals of 1 minute starting from the second minute and for the subsequent 3 minutes, amounts of dolomitic hydrated air lime and of granulation liquid were added at a rate respectively of 17% of the total mass of hydrated air dolomitic lime and 17% of the total wetting agent (corresponding to 6% in relation to dolomitic hydrated air lime) used in the entire wet granulation process (first and second steps).

During the first step of the granulation process, the stage of wetting and saturation of the starting powder and the stage of nucleation of the primary particles of dolomitic hydrated air lime take place with formation of cores of particles (nuclei) that agglomerate forming agglomerates with progressively increasing size.

The second step of the process, lasting 6 minutes, involved a different mixing regime, characterized by a vessel rotation speed of 750 rpm and a mixing tool rotation speed of 1500 rpm. During the second step, starting from the second minute and for the subsequent 3 minutes at regular intervals, amounts of dolomitic hydrated air lime and of wetting agent were added in the mixing container at a rate respectively of 8% of the total mass of dolomitic hydrated air lime and 5% of the total mass of granulation liquid (corresponding to 2% by mass in relation to the dolomitic hydrated air lime) used in the entire wet granulation process (first and second steps).

During the second step of the process the coalescence of the agglomerates formed in the first step takes place with formation of granular cores with increasing size and their consolidation (green granular cores); the second step is also characterized by competing phenomena of breakage of the granules formed and of coalescence of smaller granules and of agglomerates with the formation of new granules.

At the end of the wet granulation process, the green granules were dried in a stove at a temperature of 115° C. for a time at least equal to 12 hours to remove the free water until dried dolomitic hydrated air lime granules with a final residual content of free water of less than 0.2% by weight were obtained. The results of the determination of the free water content of the dolomitic hydrated air lime green granules produced by wet granulation process are reported in Table 1.

The dried dolomitic hydrated air lime granules were subjected to a further calcination heat treatment to obtain granular cores of air quicklime. Calcination was carried out in a laboratory TGA muffle furnace, provided with precision electronic scales and software for recording both the temperature curve and the weight loss over time. Calcination was performed under atmospheric pressure conditions, according to a heating program from room temperature to maximum temperature of 600° C. with a heating speed of 5° C./minute and a holding time at 600° C. equal to 3 hours.

After calcination, the granular material with spheroidal conformation and based on air dolomitic quicklime was cooled in a laboratory dryer before being subjected to characterization analyses.

### Granular Air Quicklime—Samples A-G

Samples A-G were prepared according to the process described above, using the following granulation liquids:
Sample A: water;
Sample B: water+hydroxy-propyl-methyl-cellulose (HPMC);
Sample C: water+polyvinyl alcohol (PVA);
Sample D: water+calcium caseinate;
Sample E: water+ethylene vinyl acetate (EVA);
Sample F: water;
Sample G: water.

In Samples B-E, the amount of added binding agent was equal to 2% by weight with respect to the total weight of the dolomitic hydrated air lime fed to the process.

Sample F was prepared in accordance with the method described above using the following mixing regime with overall duration of 15 minutes. In the first step (wetting and nucleation; duration 6 minutes) a rotation speed of 350 rpm was set for the vessel and 1800 rpm (counter-current rotation) for the mixing tool. This mixing regime was maintained for a period equal to 6 minutes and, at regular intervals of 1 minute starting from 2 minutes and for the subsequent 4 minutes, additional amounts of dolomitic hydrated air lime and of wetting agent were added at a rate respectively of 17% of the total mass of dolomitic hydrated air lime and 17% of the total wetting agent (corresponding to 6% in relation to the dolomitic hydrated air lime) used in the entire wet granulation process (first and second steps).

The second step of the process, lasting 9 minutes, involved a mixing regime characterized by an increase in the rotation speed of the vessel up to 750 rpm and a decrease in the speed of the mixing tool up to 900 rpm, and the addition, starting from 2 minutes and for the subsequent 3 minutes at regular intervals, of additional amounts of dolomitic hydrated air lime and of wetting agent at the rate, respectively, of 8% of the total mass of dolomitic hydrated air lime and 5% of the total wetting agent (corresponding to 2% in relation to dolomitic hydrated air lime) used in the entire wet granulation process.

Sample G was obtained according to the same operating methods with which Sample F was generated but, unlike the latter, it was subjected directly to the calcination treatment described above, without any preliminary drying treatment.

### Coated Granular Material—Sample H

An aliquot of Sample F, hereinafter referred to as Sample H, was treated to coat the granular cores with a hydrophobic coating.

A petrolatum (RP 56 marketed by Eni SpA, Italy), having a solid physical state at room temperature, a melting temperature between 58-67° C., a kinematic viscosity greater than 20.5 mm²/s at the temperature of 40° C. and between 5-7 mm²/s at 100° C. and having an oil content equal to 5% by weight was used as the hydrophobic coating agent.

The coating process of the dolomitic air quicklime granules was carried out in a heated rotating laboratory drum having a volume equal to 0.7 liters within which the dolomitic quicklime granules were rotated in mixture with the added petrolatum compound in the form of flakes at a temperature of 90-100° C. to melt the petrolatum. The amount of petrolatum used was equal to 2% by weight with respect to the total weight of the dolomitic air quicklime granules. The coating process lasted 30 minutes overall from reaching the operating temperature, maintained in the range 90-100° C. for a time equal to 10 minutes and then gradually decreased stopping the heat input and cooling the system for the remaining 20 minutes.

### Chemical Composition of the Granular Quicklime—Samples A-H

Based on its chemical composition, the granular material of Samples A-H is classifiable, according to the designation given in standard EN 459-1:2015 (“Building limes—Part 1: Definitions, specifications and conformity criteria”), as a dolomitic quicklime DL90-30-Q having, in relation to the finished product:
a calcium and magnesium content in terms of the summation of CaO+MgO≥90%;
magnesium content (MgO)≥30%;
residual CO₂ content≤6% and SO₃ content≤2%.

### Comparative Samples—Samples I-J

For comparative purposes, two samples of industrially produced natural granular dolomitic air quicklime (Samples I-J) obtained by calcination of calcium carbonate in lumps coming from two different extraction sites and subsequent comminution and sieving (particle size distribution of the granules included for 98% by weight of the granular mass in the size range 2-10 mm) were taken into consideration.

Based on the classification given in standard EN 459-1:2015 (“Building limes—Part 1: Definitions, specifications and conformity criteria”), Samples I-J belong to class DL90-30-Q, having the following composition in relation to the finished product:
calcium and magnesium content in terms of the summation CaO+MgO≥90%;
magnesium content (MgO)≥30%;
residual CO₂ content≤6% and SO₃ content≤2%.

### Particle Size Analysis

The particle size analysis of the granular quicklime samples was carried out by dry-sieving by shaking in accordance with standard EN 459-2:2010 (“Building limes—Part 2: Test Methods”), EN 932-2:2000 (“Test methods for determining the general properties of aggregates—Methods for reducing laboratory samples”) and EN 933-1:2012 (“Tests for determining the geometric characteristics of aggregates—Part 1: Determination of the particle size distribution—Granulometric analysis by sieving”) in test sieves having square-shaped apertures as reported in standard EN 933-2:2020 (“Tests for determining the geometric characteristics of aggregates—Part 2: Determination of the particle size distribution—Test sieves, nominal sizes and apertures”): the test was carried out with a series of ISO 3310 sieves stacked into a column in order of (square) aperture size decreasing from top to bottom (16 mm, 14 mm, 12.5 mm, 10 mm, 9 mm, 8 mm, 7.1 mm, 6.3 mm, 5 mm, 4 mm, 3.15 mm, 2 mm, 1 mm, 0.5 mm) so as to have an opening area of the apertures in geometric progression.

From the cumulative curve of the particle size distribution determined for each sample, the characteristic diameters D₁₀, D₅₀ and D₉₀ were obtained, indicating respectively the size of the particles corresponding to 10%, 50% (median) and 90% by weight of the cumulative curve, as well as the average diameter (Dₐᵥₑ) and the amplitude of the particle size distribution (ratio D₉₀/D₁₀).

The characterizing values of the particle size distribution of the samples analyzed are reported in Table 1.

### Determination of the Mechanical Compressive Strength

The compressive load until rupture of the granular quicklime was determined by means of a compression-functioning dynamometer, provided with a piston that imparts an increasing compressive load to the granule until it breaks. The dynamometer records the maximum force applied until the granule breaks. The compressive load until rupture is expressed as the average value of thirty measurements performed on thirty granules of the same sample of material having a diameter in the range D₅₀±15%, where D₅₀ is the value of the median of the particle size distribution of the granular quicklime analyzed.

The results of the determination of the mechanical compressive strength are reported in Table 1.

### Determination of the Shatter Test Index (ISTₓ)

A sample of approximately 150 grams of granular quicklime was subjected to a shatter test consisting of a series of collision-controlled impacts of the particles inside a test chamber consisting of a cylindrical steel container (internal diameter equal to 78 mm and length equal to 690 mm), provided with closures at both ends. The test chamber containing the granular material to be tested was kept rotating around a pin fixed on the outer lateral surface of the chamber, at the median cross-section of the chamber itself. The chamber was kept rotating at a rotation speed equal to 15 rpm for a total number of complete rotations equal to 75. Before and after the shatter test, the percentage fraction by weight of granular material passing through the 0.5 mm and/or 1 mm square aperture sieve was determined. The ISTₓ (expressed in percentage points, pp) is calculated according to the formula:

$${IST}_{x} = {FP}_{f} - {FP}_{i}$$

where:
FPᵢ is the percentage fraction by weight of the granular material passing through the sieve having square aperture with side x mm before the test; FP_{f} is the percentage fraction by weight of the granular material passing through the same sieve having square aperture with side x after the test;
x is the net opening of the aforesaid sieve, i.e. the length in mm of the side of the square aperture of the sieve.

The results of the determination of the IST₁ and IST_{0.5} shatter test indices, expressed in percentage points (pp), are reported in Table 1.

### Reactivity in Water

The slaking test for the determination of the reactivity of granular quicklime in water was carried out according to the provisions of standard EN 459-2:2010 (“Building limes—Part 2: Test methods”). The reactivity test was carried out on the granular material as it is, i.e. without reducing the particle size to values≤0.2 mm (as required by the standard for the materials not passing 100% through a 5 mm sieve).

The results of the water reactivity tests are reported in Table 2.

### Physical Characteristics

For each sample constituting the specific series of granular materials with spheroidal conformation and based on dolomitic air quicklime, the specific surface (BET) of the granular cores was determined by multilayer physical adsorption of nitrogen on the surface of the uncoated granular material in accordance with the BET method; the total pore volume (BJH) and the average pore diameter (Dₚ₋ₐᵥₑ) were instead determined by means of nitrogen desorption isotherms and calculated on the assumption of pores having cylindrical geometry in accordance with the method BJH.

The results of the measurements are reported in Table 1.

TABLE 1
CHARACTERIZATION OF THE DOLOMITIC QUICKLIME GRANULES³

| | A | B | C | D | E | F¹ | G² | I* | J* |
|---|---|---|---|---|---|---|---|---|---|
| D₁₀ [mm]⁴ | 2.19 | 2.37 | 2.30 | 2.68 | 2.88 | 3.10 | 3.21 | 2.71 | 2.63 |
| D₅₀ [mm]⁴ | 4.25 | 3.97 | 4.57 | 4.11 | 4.74 | 4.78 | 4.87 | 5.37 | 3.97 |
| D₉₀ [mm]⁴ | 7.96 | 8.26 | 7.66 | 7.64 | 8.92 | 8.68 | 8.69 | 9.15 | 7.52 |
| Dₐᵥₑ [mm]⁴ | 4.71 | 4.61 | 4.25 | 4.53 | 5.40 | 5.31 | 5.37 | 5.68 | 4.44 |
| D₉₀/D₁₀ [—]⁴ | 3.83 | 3.49 | 3.33 | 2.85 | 3.09 | 2.81 | 2.71 | 3.42 | 2.86 |
| IST_{0.5} [pp]⁴ | 0.22 | 0.16 | 0.38 | 0.04 | 0.25 | 0.49 | 0.27 | 2.95 | 2.52 |
| IST₁ [pp]⁴ | 0.43 | 0.14 | 0.55 | 0.03 | 0.40 | 0.89 | 0.52 | 3.47 | 2.96 |
| BET [m²/g]⁴ | 23.77 | 23.59 | 22.96 | 22.39 | 23.46 | 24.50 | 25.82 | 4.21 | 5.78 |
| BJH [cm³/g]⁴ | 0.15 | 0.13 | 0.14 | 0.15 | 0.12 | 0.17 | 0.17 | 0.01 | 0.02 |
| Dₚ₋ₐᵥₑ [Å]⁴ | 200.60 | 200.81 | 203.80 | 254.60 | 186.25 | 221.99 | 235.23 | 166.17 | 137.08 |
| Compressive | 74.22 | 75.24 | 73.87 | 82.39 | 85.24 | 68.29 | 68.62 | 68.62 | 92.55 |
| strength | | | | | | | | | |
| [N/granule]⁴ | | | | | | | | | |
| Free water [%]⁵ | 21.32 | 22.93 | 23.07 | 21.75 | 22.73 | 22.34 | 22.28 | — | — |

¹as Sample A, but granulated with different mixing regime;
²as Sample F, but calcined without preliminary drying;
³results expressed as the average value of the values determined on the five samples that make up each of the series A-G and each of the comparative series I-J;
⁴parameter determined by analysis of the calcined sample;
⁵% value referred to the weight of the granular material before drying;
*comparative sample (natural granular quicklime).

TABLE 2
SLAKING TEST EN 459-2: 2010

| | A | B | C | D | E | F¹ | G² | H³ | I* | J* |
|---|---|---|---|---|---|---|---|---|---|---|
| time t₅₀ [min:sec.] | 01:18 | 01:20 | 01:28 | 05:00 | 01:24 | 02:02 | 02:53 | T′max <50° C. | 56:10 | 15:40 |
| time t₆₀ [min:sec.] | 48:30 | T′max <60° C. | 36:50 | T′max <60° C. | 27:50 | 36:02 | 37:37 | T′max <60° C. | T′max <60° C. | T′max <60° C. |
| time tᵤ (80% | 08:30 | 08:30 | 10:40 | 11:10 | 11:10 | 08:42 | 10:03 | 30:40 | 01:18 | 07:40 |
| reaction) [min:sec.] | | | | | | | | | | |
| Temperature Tᵤ | 52.1 | 51.7 | 52.7 | 51.3 | 54.0 | 52.9 | 52.8 | 22.8 | 46.9 | 44.8 |
| (80% reaction) [° C.] | | | | | | | | | | |
| Temperature T′ₘₐₓ | 60.1 | 59.7 | 60.8 | 59.2 | 62.5 | 61.2 | 61.0 | 23.6 | 53.5 | 51.0 |
| [° C.] | | | | | | | | | | |

¹as Sample A, but granulated with different mixing regime;
²as Sample F, but calcined without preliminary drying;
³as Sample F, but comprising hydrophobic coating: over the test time (50 minutes) Sample H has reached a maximum temperature of 23.6° C., i.e. the water/lime system has undergone a thermometric rise by only 3.6° C.;
*comparative sample (natural granular quicklime).

The results of the characterization show that the granular quicklime according to the present disclosure possesses a high mechanical strength, with values around 70 N/granule, when only water is used as granulation liquid, or higher values when the granulation liquid also includes a binding agent. These values are close to those of natural granular quicklime.

The data further show that the reactivity of granular quicklime according to the present disclosure is very high and significantly higher than that of natural granular quicklime.

The hydrophobic coating (Sample H) significantly reduces the reactivity of the granular cores to water, thus being an effective means for keeping the properties of the granular lime unaltered during storage.

The IST shatter test index also highlights the high resistance to wear and to abrasion of the granular quicklime according to the present disclosure and therefore the limited tendency to generate fine powders during handling and transport.

1. A granular material comprising:
a granular core comprising quicklime, said granular core having an overall concentration of CaO and MgO equal to or greater than 80% by weight;
wherein said granular core has:
compressive load until rupture equal to or greater than 50 N/granule,
a slaking time t₅₀ in water not exceeding 10 minutes, when the concentration of MgO is greater than 5% by weight with respect to the weight of the granular core, and
a slaking time t₆₀ in water not exceeding 6 minutes, when the concentration of MgO is less than or equal to 5% by weight with respect to the weight of the granular core.

2. The granular material according to claim 1, wherein said quicklime is selected from: calcium quicklime having an MgO content equal to or less than 5% by weight; magnesium quicklime having an MgO content higher than 5% by weight and lower than 30% by weight, and dolomitic quicklime having an MgO content equal to or greater than 30% by weight.

3. The granular material according to claim 1, wherein said quicklime is a dolomitic quicklime and the Mg/Ca weight ratio is 0.36 to 0.62.

4. The granular material according to claim 1, wherein said quicklime is a magnesium quicklime and the Mg/Ca weight ratio is 0.05 to 0.35.

5. The granular material according to claim 1, wherein said quicklime is a calcium quicklime and the Mg/Ca weight ratio is 0.002 to 0.04.

6. The granular material according to claim 1, wherein said granular core has a slaking time t₅₀ in water not exceeding 10 minutes.

7. The granular material according to claim 1, wherein said granular core has a slaking time t₆₀ in water not exceeding 6 minutes.

8. The granular material according to claim 1, having a particle size distribution wherein at least 90% by weight of the mass of the granular material is formed by granular cores having size in the range 1-10 mm.

9. The granular material according to claim 1, comprising chemically bonded water in an amount lower than 1% by weight said percentage being referred to the weight of the granular core.

10. The granular material according to claim 1, having an IST₁ shatter test index lower than 1.5 percentage points and/or IST_{0.5} lower than 0.5 percentage points.

11. The granular material according to claim 1, further comprising a hydrophobic coating covering the granular core.

12. The granular material according to claim 11, wherein said hydrophobic coating comprises a compound selected from: stearic acid, calcium stearate, silane or siloxane compounds, waxes or paraffinic oils, petrolatum compounds.

13. A method for the preparation of a granular material according to claim 1, the method including:
a. preparing a mixture comprising:
a1. hydrated lime having an overall concentration of CaO and MgO equal to or greater than 80% by weight, said weight percentage referring to the weight of the calcined hydrated lime; and
a2. a granulating fluid comprising water;
b. mixing said mixture until obtaining wet granular cores comprising particles of said hydrated lime; and
c. calcining said wet granular cores to obtain calcined granular cores comprising quicklime.

14. Use of the granular material according to claim 1 in a metallurgical process.

15. Use of the granular material according to claim 1 for the treatment of an agricultural soil.

16. The method of claim 13, further comprising:
d. coating said calcined granular cores with a hydrophobic coating layer to obtain a coated granular material.

17. The granular material according to claim 1, wherein said granular core has a slaking time t₅₀ in water not exceeding 5 minutes.

18. The granular material according to claim 1, wherein said granular core has a slaking time t₅₀ in water not exceeding 3 minutes.

19. The granular material according to claim 1, wherein said granular core has a slaking time t₆₀ in water not exceeding 4 minutes.

20. The granular material according to claim 1, wherein said granular core has a slaking time t₆₀ in water not exceeding 2 minutes.
